(19) United States
(12) Patent Application Publication
(10) Pub. No.: US 2016/0185155 A1
(43) Pub. Date: Jun. 30, 2016

(54) Paint Roller Grid

(71) Applicant: Bercom International, LLC, Chanhassen, MN (US)

(72) Inventors: Mark W. Bergman, Minnetonka, MN (US); Jeffrey T. Given, St. Paul, MN (US); Matthew V. Leydeh, St.Paul, MN (US); Jeffrey B. Waffensmith, North Oaks, MN (US)

(21) Appl. No.: 14/930,156

(22) Filed: Nov. 2, 2015

Related U.S. Application Data
(60) Provisional application No. 62/074,428, filed on Nov. 3, 2014.

(51) Int. Cl. B44D 3/12

(52) U.S. Cl. CPC B44D 3/128

(57) ABSTRACT

An apparatus is configured for use with a container having a top rim. The apparatus includes a plurality of hooks configured to hang on the rim; a handle extending above the rim and comprising a semi-tubular shape; and a panel extending below the rim and comprising a textured surface, the textured surface comprising an array of raised elements.

### CROSS REFERENCE TO RELATED APPLICATIONS

This application claims the benefit of priority from U.S. Provisional Patent Application Ser. No. 62/074,428, filed Nov. 3, 2014, for a “Paint Roller Grid,” which is fully incorporated herein by reference.

### BACKGROUND

A paint roller is often used with paint tray, which generally rectangular and has a sufficiently wide inner tray cavity to receive a paint roller therein. Typical nominal tray widths of 18 inches, 9 inches, 6-7 inches and 4 inches are commonly available for use with paint rollers of varying width. A typical 9-inch paint roller tray will have a useful paint capacity of about a quart of paint. The bottom of the paint tray cavity is typically flat, with three upright sides and a fourth side, which is sloping. This sloping side provides the means for rolling the paint roller down into the paint in the cavity. The roller can then be rolled along the sloping side to remove excess paint from the roller and to evenly distribute paint along the roller prior to its use for applying paint to a target surface.

However, the capacity of a tray is relatively limited, requiring frequent refills during use. Moreover, the wide footprint and shallow depth of a tray can lead to difficulties in handling and concerns about spilling during movement. Accordingly, for large jobs, some users prefer to contain their paint in a larger container such as a 1-gallon, 2-gallon, or 5-gallon bucket, for example. Conventional paint rollers screens for use in such buckets are known, which generally have a screen panel against which a user may roll and press a paint roller to remove excess paint therefrom and to evenly distribute paint along the roller. However, because of the many holes in a conventional paint roller screen, the screen can be difficult to clean when paint dries within the holes.

Although the discussion herein will focus on paint, it is understood that paint trays and other containers are used for the application of other fluid materials (e.g., another surface coating such as a protectant or varnish; an adhesive; a roofing, pavement or driveway coating; a textured surface material, etc.).

### SUMMARY

In one aspect, an apparatus is configured for use with a container having a top rim. The apparatus comprises a plurality of hooks configured to hang on the rim; a handle extending above the rim and comprising a semi-tubular shape; and a panel extending below the rim and comprising a textured surface, the textured surface comprising an array of raised elements.

This disclosure, in its various combinations, either in apparatus or method form, may also be characterized by the following listing of items:

1. An apparatus configured for use with a container having a top rim, the apparatus comprising:

a plurality of hooks configured to hang on the rim;

a handle extending above the rim and comprising a semi-tubular shape; and

a panel extending below the rim and comprising a textured surface, the textured surface comprising an array of raised elements.

2. The apparatus of item 1 formed as a single piece of material.

3. The apparatus of any of items 1-2 further comprising a protrusion positioned on at least one of the plurality of hooks, the protrusion configured to engage with the rim.

4. The apparatus of any of items 1-3 wherein the array of raised elements comprises a plurality of curvilinear ridges.

5. The apparatus of any of items 1-4 wherein at least one of the plurality of curvilinear ridges comprises a peak along a center line of the apparatus.

6. The apparatus of any of items 1-5 that is symmetrical about a center line.

7. The apparatus of any of items 1-6 further comprising an aperture between the handle and the panel.

8. The apparatus of any of items 1-7 further comprising an aperture positioned on a top wall of the panel.

9. The apparatus of any of items 1-8 further comprising a recess positioned on at least one of the raised elements.

10. The apparatus of any of items 1-9 having a shell construction and a plurality of reinforcement members.

11. The apparatus of item 10 wherein the plurality of reinforcement members comprises a handle reinforcement member positioned in the handle.

12. The apparatus of any of items 10-11 wherein the plurality of reinforcement members comprises a central reinforcement member positioned along a central line of symmetry of the apparatus.

13. The apparatus of any of items 10-12 wherein the plurality of reinforcement members comprises a side reinforcement member contacting a side wall of the apparatus.

14. The apparatus of any of items 10-13 wherein the panel comprises a convex curvature.

15. The apparatus of any of items 1-14 further comprising a side wall extending from the textured surface.

16. The apparatus of item 15 wherein the side wall extends from the textured surface at an obtuse angle.

17. The apparatus of any of items 1-16 wherein the handle comprises a notch therein.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a front perspective view of a first embodiment of an exemplary paint roller grid of the present disclosure.

FIG. 2 is a front view of the first exemplary paint roller grid.

FIG. 3 is a back view of the first exemplary paint roller grid.

FIG. 3A is a back perspective view of the first exemplary paint roller grid.

FIG. 4 is a left side elevation view of the first exemplary paint roller grid.

FIG. 5 is a right side elevation view of the first exemplary paint roller grid.

FIG. 6 is a top view of the first exemplary paint roller grid.

FIG. 7 is a bottom view of the first exemplary paint roller grid.

FIG. 8 is a front perspective view of a pail containing the first exemplary paint roller grid.

FIG. 9 is a front perspective view of a pail containing the first exemplary paint roller grid having a paint roller attached thereto.

FIG. 9A is a cross-sectional perspective view of a pail containing the first exemplary paint roller grid having a paint roller attached thereto, taken along line A-A of FIG. 9.

FIG. 9B is a cross-sectional perspective view of a pail containing the first exemplary paint roller grid having a paint roller attached thereto, taken along line B-B of FIG. 9.

FIG. 10 is a front perspective view of the components of FIG. 8 in use.

FIG. 11 is a perspective view of a stack of six of the first exemplary paint roller grids.

FIG. 12A is a front perspective view of a user holding an exemplary paint roller grid in a first configuration.

FIG. 12B is a back perspective view of a user holding an exemplary paint roller grid in the first configuration of FIG. 12A.

FIG. 13A is a front perspective view of a user holding an exemplary paint roller grid in a second configuration.

FIG. 13B is a back perspective view of a user holding an exemplary paint roller grid in the second configuration of FIG. 13A.

FIG. 14 is a back view of the exemplary paint roller grid in a combination with three paint rollers.

FIG. 15 is a front perspective view of a second embodiment of an exemplary paint roller grid of the present disclosure.

FIG. 16 is a front view of the second exemplary paint roller grid.

FIG. 17 is a back view of the second exemplary paint roller grid.

FIG. 18 is a left side view of the second exemplary paint roller grid.

FIG. 19 is a right side view of the second exemplary paint roller grid.

FIG. 20 is a top view of the second exemplary paint roller grid.

FIG. 21 is a bottom view of the second exemplary paint roller grid.

FIG. 22 is a front perspective view of a third embodiment of an exemplary paint roller grid of the present disclosure.

FIG. 23 is a front view of the third exemplary paint roller grid.

FIG. 24 is a back view of the third exemplary paint roller grid.

FIG. 24A is a back perspective view of the third exemplary paint roller grid.

FIG. 25 is a left side view of the third exemplary paint roller grid.

FIG. 26 is a right side view of the third exemplary paint roller grid.

FIG. 27 is a top view of the third exemplary paint roller grid.

FIG. 28 is a bottom view of the third exemplary paint roller grid.

FIG. 29 is a front perspective view of a can containing the third exemplary paint roller grid.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

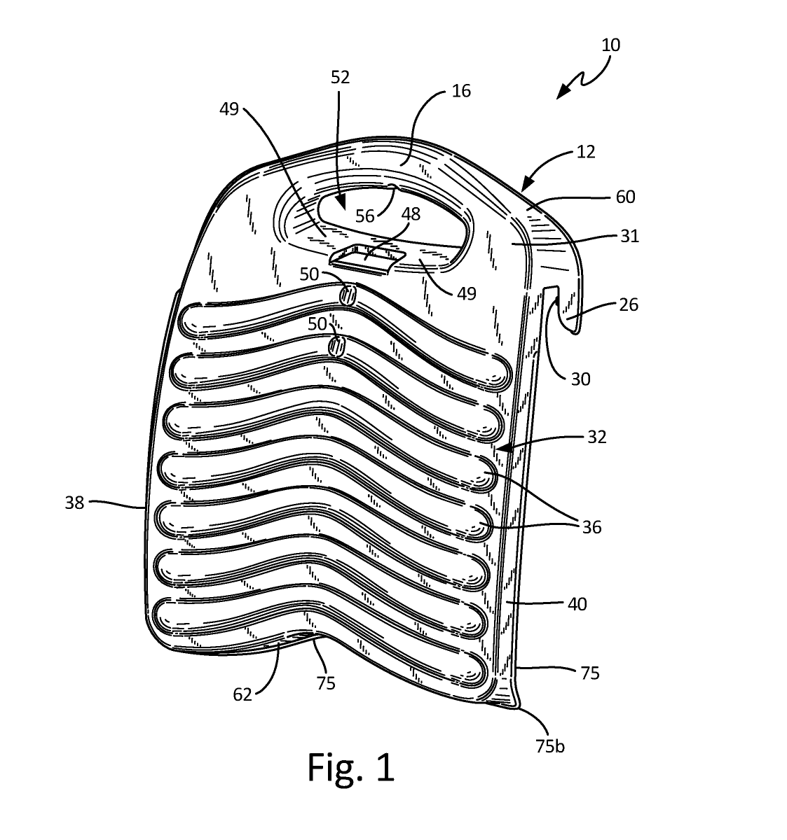

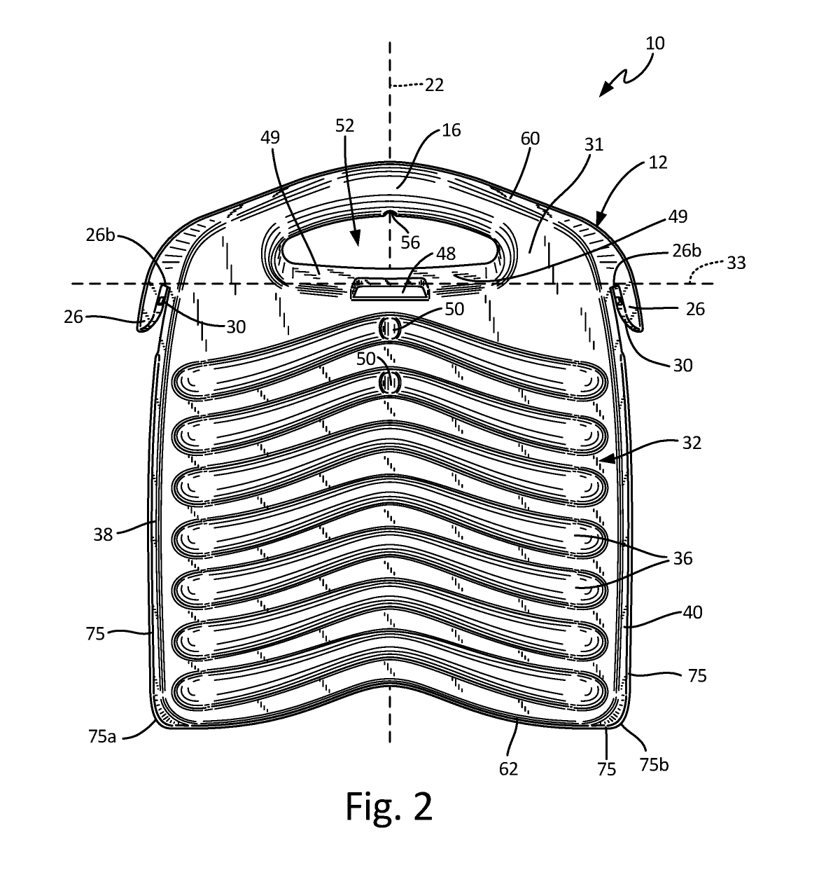

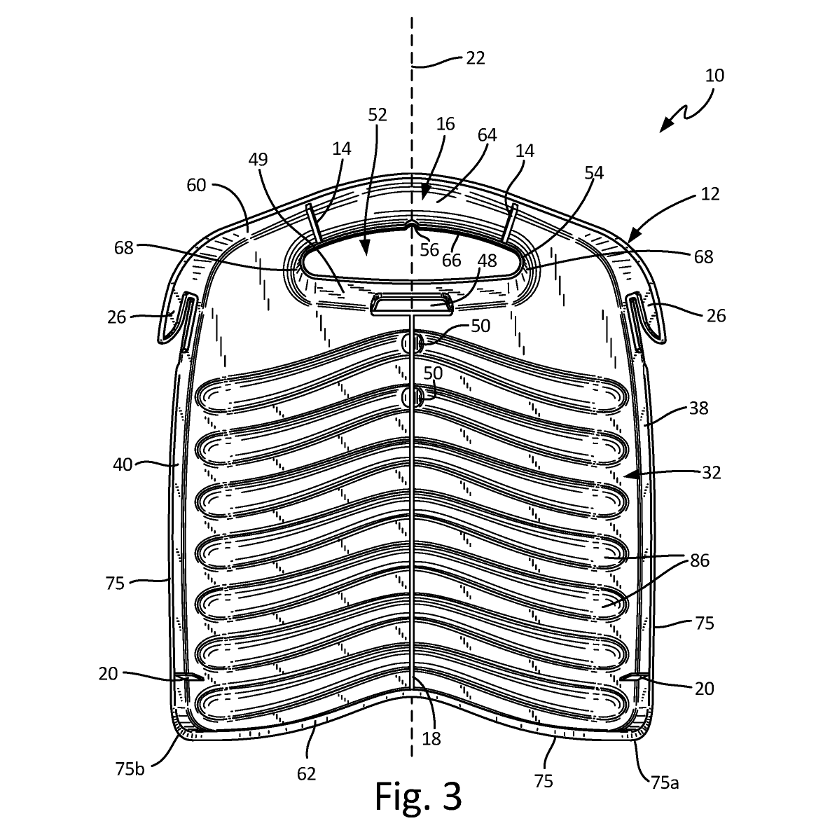

FIG. 1 is a front perspective view of a first exemplary paint roller grid apparatus 10 of the present disclosure. FIG. 2 is a front view thereof, and FIG. 3 is a back view thereof. As shown in FIGS. 1-3, in an exemplary embodiment, paint roller grid 10 is formed in a single piece. Such forming may be by a method such as injection molding, for example. In an exemplary embodiment, paint roller grid 10 can be considered to be constructed as a shell 12 that is structurally reinforced with members such as handle reinforcement ribs 14 in a handle 16, central reinforcement rib 18 positioned along a central line of symmetry 22, and side reinforcement ribs 20 contacting side walls 38, 40. While a particular depiction of structural reinforcement members is shown, including reinforcement ribs 14, central reinforcement rib 18 and side reinforcement ribs 20, it is contemplated that structural reinforcement members may be provided in shapes and locations other than those shown to add strength and rigidity to paint roller grid 10. In an exemplary embodiment, paint roller grid 10 is symmetrical about center line 22.

Such a shell construction provides for a light-weight structure that offers enhanced ease of use and prevents user fatigue. The light-weight shell structure also provides for material savings and increases economies in manufacturing and transport. The paint roller grid 10 may be formed of a suitable material (such as polypropylene or other similar plastic) to withstand the harmful effects of paint, stain or varnish, and to provide a durable and generally rigid paint roller grid structure. Additionally, paint roller grid 10 is environmentally friendly because it is reusable; further, in an exemplary embodiment, the material from which paint roller grid 10 is manufactured is recycled, such as from car battery cases. Moreover, the material in an exemplary embodiment is non-corrosive, to prevent the formation of rust from repeated use and cleaning.

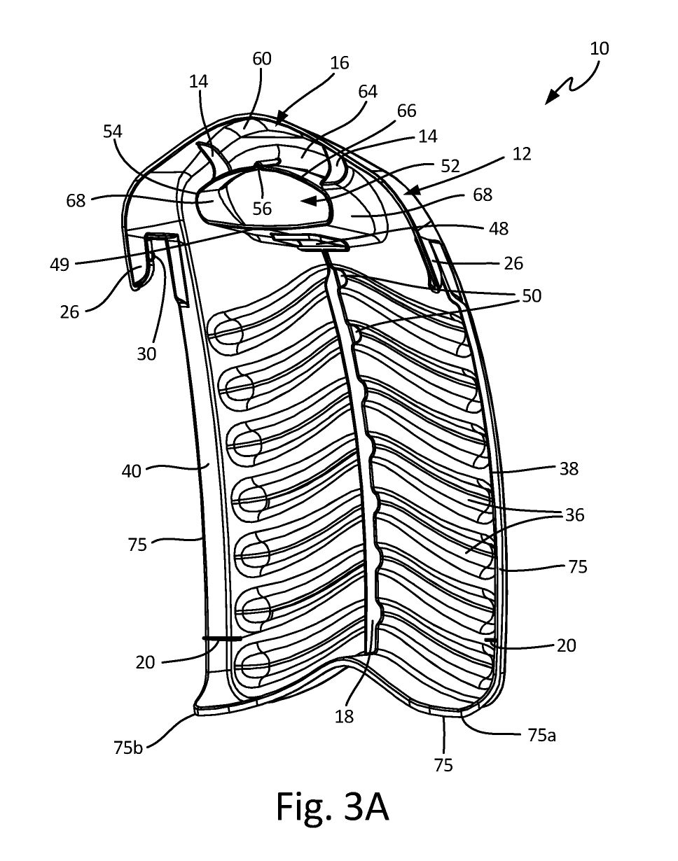

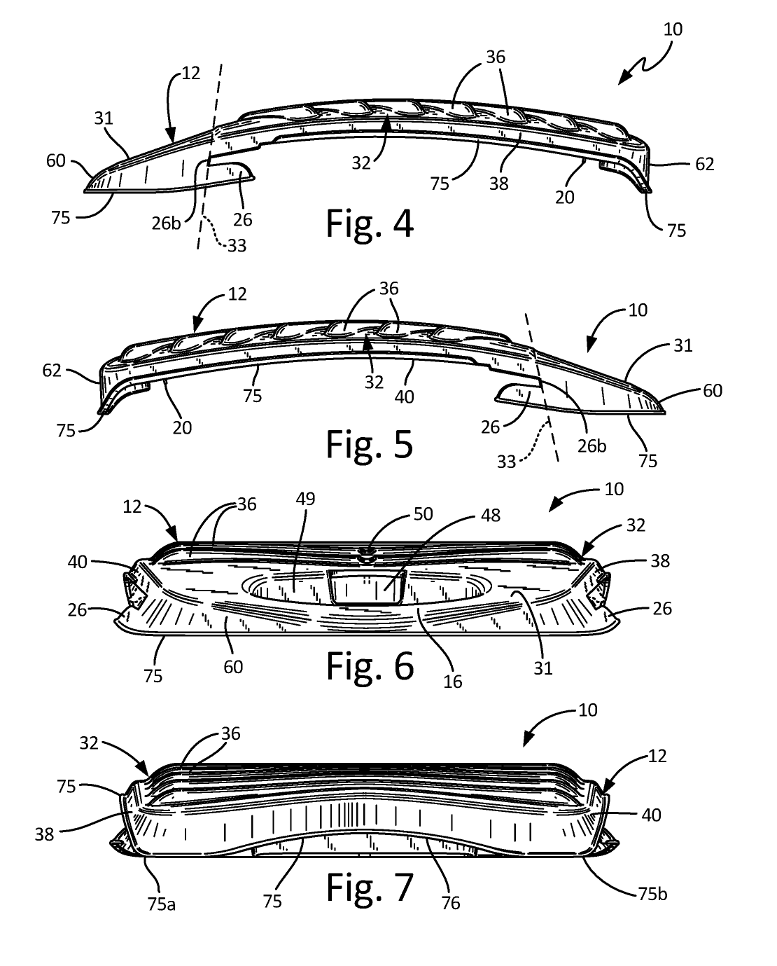

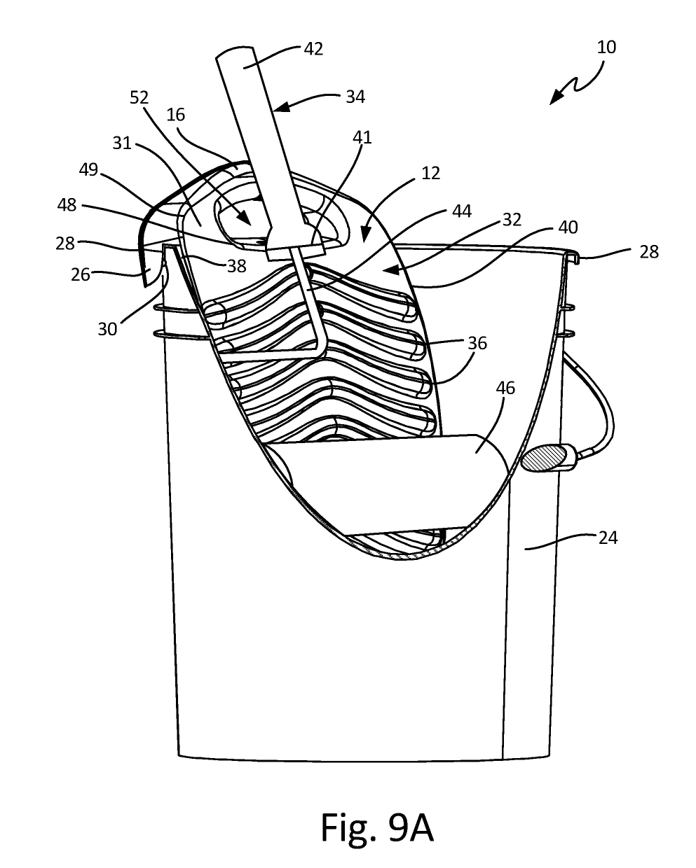

FIGS. 4, 5, 6 and 7 are left, right, top and bottom views, respectively, of the exemplary paint roller grid 10. FIG. 8 is a perspective view of paint roller grid 10 attached to a container 24 configured for holding paint or another substance to be applied to a surface by a user. In the illustrated embodiment, container 24 is a conventional plastic 5-gallon bucket. However, other suitable containers include paint cans and other buckets and containers of varying sizes. Moreover, it is contemplated that paint roller grid 10 may be provided in different sizes to fit containers 24 of different sizes.

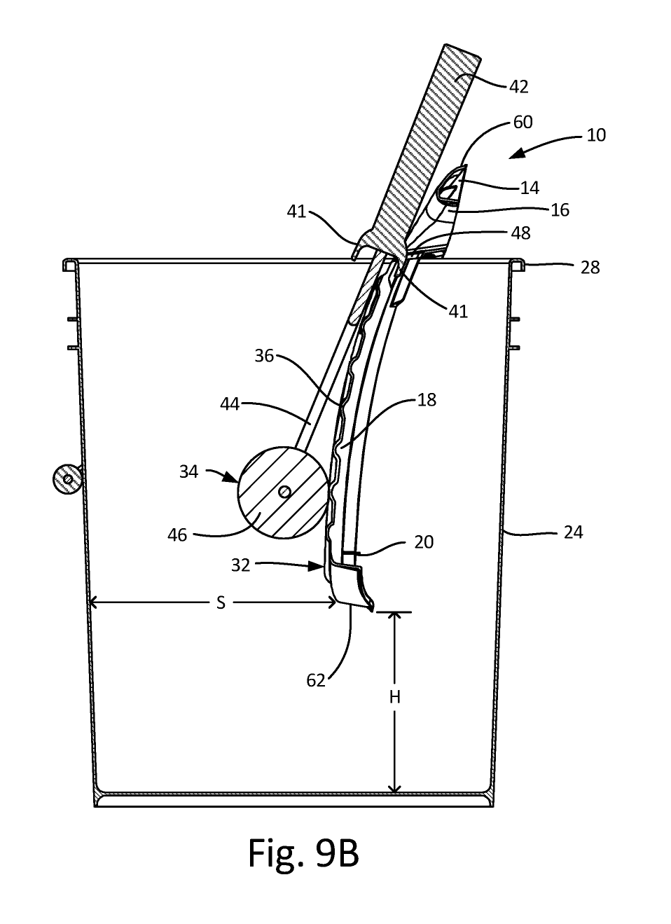

As shown in FIGS. 8, 9 and 9A, hooks 26 are positioned to hang over top rim 28 of container 24. In FIG. 9A, part of container 24 is cut away in a cross-sectional view taken along line A-A of FIG. 9 to show the engagement between hooks 26 with top rim 28 of container 24. In an exemplary embodiment, each hook 26 has a protrusion 30 (shown in FIGS. 1, 2, 3A and 9A) on an inner surface thereof that extends under rim 28 to affirmatively engage with rim 28, thereby providing a snap-fit attachment of paint roller grid 10 to container 24 allowed by flexing of the distal ends of hooks 26. This two-point affirmative engagement of hooks 26 with rim 28 prevents separation of paint roller grid 10 from container 24 when force is exerted on paint roller grid 10 by a user 58 exerting force and motion on paint roller 34 upon panel 32.

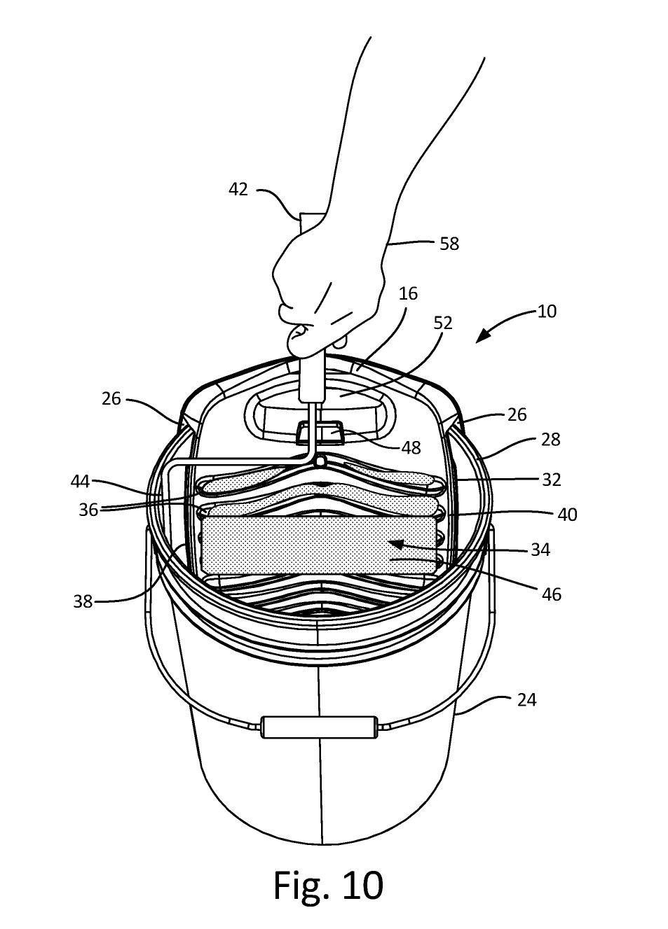

In an exemplary embodiment, when paint roller grid 10 is assembled onto container 24, handle 16 extends above rim 28 and panel 32 extends below rim 28. Panel 32 provides a textured rolling surface for paint roller 34, shown in FIGS. 9 and 10. In an exemplary embodiment, panel 32 comprises a plurality of ridges 36, thereby offering a textured surface on which paint roller 34 rolls. In an exemplary embodiment, each ridge 36 is a curvilinear element having rounded edges, wherein the highest point of the curve is along center line 22. Accordingly, paint or another fluid on the surface of panel 32 is channeled by gravity away from center line 22 and toward and along the side walls 38, 40 of paint roller grid 10. The paint or other fluid then flows by gravity down paint roller grid 10 and back into the pool of fluid in container 24. This feature prevents pooling of fluids on panel 32, thereby allowing the surface of the panel 32 to accept paint applied thereto from paint roller 34.

As shown in FIGS. 4, 5, and 9B in an exemplary embodiment, paint roller grid 10 has a convex curvature of handle 16, upper front face 31 and panel 32. In an exemplary embodiment, upper front face 31 and panel 32 are continuous with each other and interface at an uninterrupted surface at demarcation line 33. With reference to FIG. 2, for ease of discussion, this disclosure refers to the front surface of paint roller grid 10 above wall 49 and demarcation line 33 as upper front face 31 and the front surface of paint roller grid 10 below wall 49 and demarcation line 33 as panel 32. In an exemplary embodiment, demarcation line 33 marks the level on paint roller grid 10 at which wall 49 extends back from the front surface of paint roller grid 10. Moreover, in an exemplary embodiment, demarcation line 33 marks the location at which hooks 26 extend downward from top wall 60. Thus, when paint roller grid 10 is attached to a container 24 as shown in FIGS. 8-10, demarcation line 33 marks the level of rim 28 of container 24. In one exemplary embodiment, each side wall 38 and 40 has an upper edge 26b of a cutout therein that serves to define its respective hook 26. In such an embodiment, upper edge 26b is co-linear with demarcation line 33 when the paint roller grid 10 is attached to container 24.

The convex curvature of panel 32 allows for ease of contact between paint roller 34 and top, middle and bottom portions of panel 32. Moreover, the curvature allows for a greater clearance space “S” (labeled in FIG. 9B) between a bottom of panel 32 and an interior of container 24, allowing for more space for maneuvering paint roller 34 within container 24 than might be available with a panel not having a curvature. The curvature also encourages paint run-off toward the bottom by gravity.

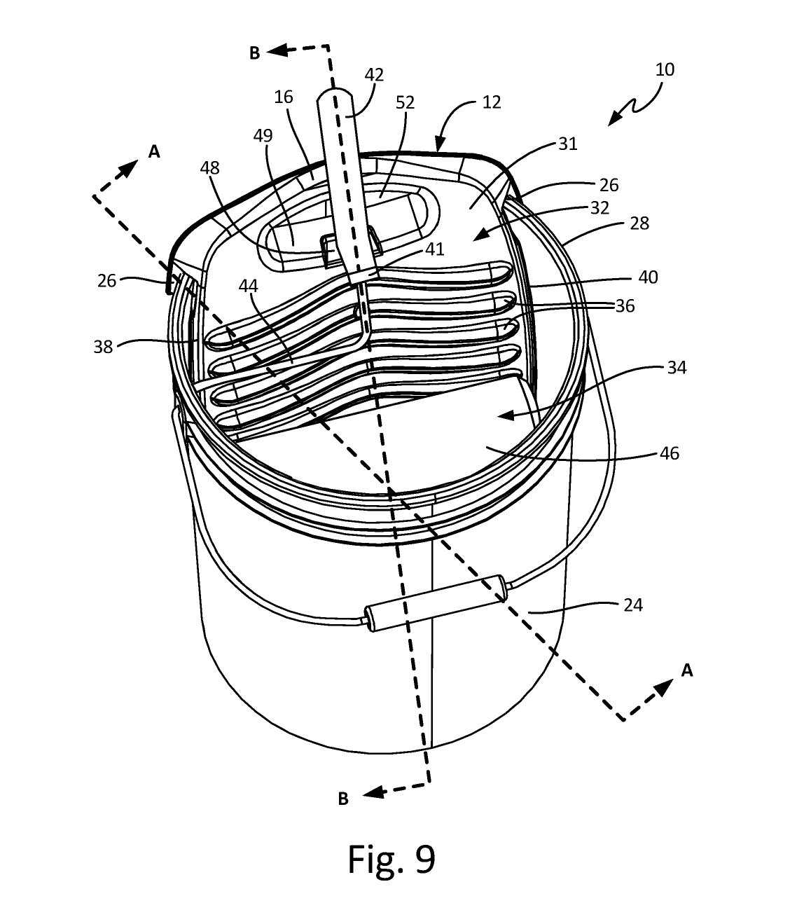

In an exemplary embodiment, from the front view and rear views, it can be seen that bottom wall 62 follows the contours of ridges 36. Moreover, as shown in FIG. 7, panel 32 is also has a convex curvature across its width. Bottom wall 62 also follows this curvature, resulting in a curved back edge 76 of bottom wall 62. The curvature of bottom wall 62 contributes to an aesthetically pleasing paint roller grid 10.

As shown in FIG. 9, a conventional paint roller 34 includes handle 42, frame 44, and roller 46. Paint roller grid 10 in an exemplary embodiment includes aperture 48 positioned on a top wall 49 of panel 32 to accept a hook 41 commonly provided on handle 42 of paint roller 34. As shown in FIG. 9B, hook 41 is inserted into aperture 48 on top wall 49 of panel 32. Accordingly, a user may attach a paint roller 34 to paint roller grid 10 when not in active use. Recesses 50 are provided on at least some of the ridges 36 to accommodate frame 44 of paint roller 34 (see, e.g., FIGS. 1 and 2).

As shown in FIG. 9B, in an exemplary embodiment, paint roller grid 10 is sized with respect to a container 24 for which it will be used so that a length of panel 32 between hooks 26 and bottom wall 62 is such that a clearance height “H” between the bottom wall 62 and the bottom of container 24 allows for passage of at least the diameter of roller 46. Thus, when paint roller 34 is not attached to paint roller grid 10, a user may maneuver roller 46 within container 24 and under paint roller grid 10, such as to stir a liquid contained therein or capture remnants of the liquid on roller 46, for example. Moreover, because paint roller grid 10 is securely attached to edge rim 28 of container 24, more room is available within container 24 for the manipulation of paint roller 46, compared to the use of a conventional paint grid that merely rests along the bottom of container 24.

In an exemplary embodiment, left and right side walls 38, 40 are angled back from panel 32 to hold panel 32 away from an interior surface of container 24, thereby preventing fluid buildup on the left and right walls 38, 40 of paint roller grid 10. Moreover, left and right side walls 38, 40 lend rigidity to the shell 12 of paint roller grid 10. As shown in FIGS. 1-7, a thickened edge rim 75 on top wall 60, left and right side walls 38, 40 and bottom wall 62 is provided to additionally lend rigidity to the shell 12. Lower corners 75a and 75b of the rim 75 (see, e.g., FIG. 7) engage an inner surface of the side wall of container 24 when the paint roller grid 10 is mounted on the container 10 for use, such as seen in FIGS. 8-10, adding further stability to the paint roller grid 10 as a user contacts it with the paint roller 34.

In an exemplary embodiment, handle 16 is formed as a semi-tubular element having rounded top, front and bottom walls with an open back, as show in FIGS. 1-3A and 6. Aperture 52 is provided between handle 16 and panel 32. In an exemplary embodiment, as shown in FIGS. 3 and 3A, for example, handle 16 includes a central portion of top wall 60, front handle wall 64, and bottom handle wall 66. In an exemplary embodiment, top wall 60, front handle wall 64 and bottom handle wall 66 are continuous with each other and flow smoothly into each other, with no discernable interfaces, in a semi-tubular shape. Top wall 60, front handle wall 64 and bottom handle wall 66 are curved for user comfort and aesthetic value. Rigidity is added to handle 16 by handle reinforcement ribs 14.

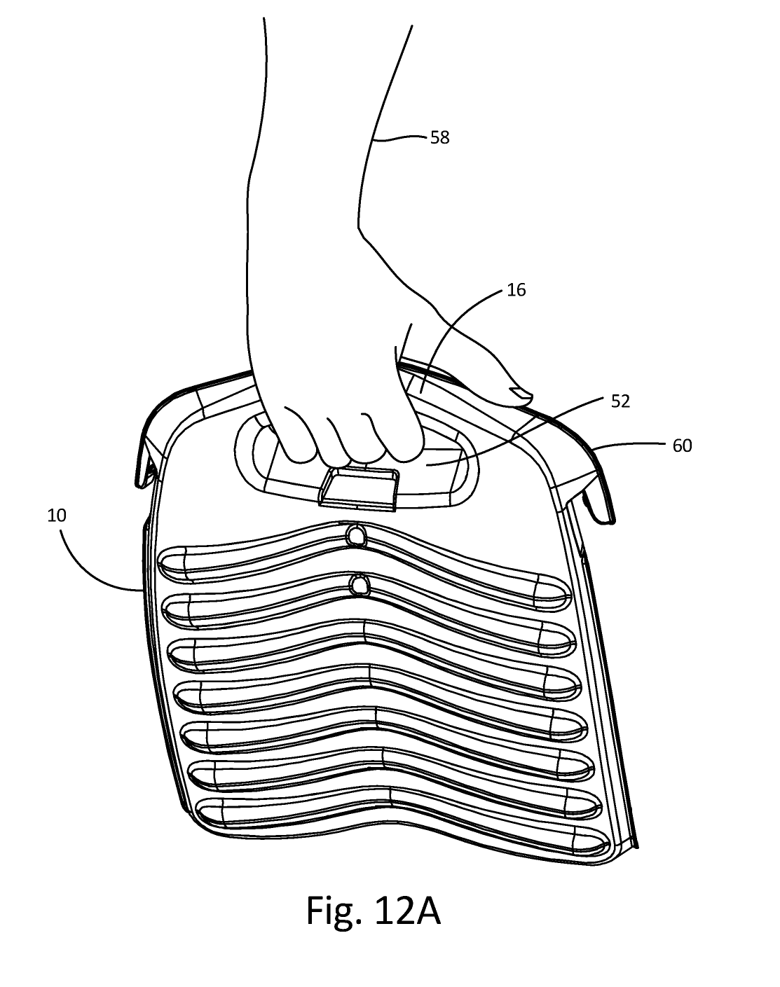

In a typical method of use, a user inserts his or her fingers through aperture 52 (from the front or back of aperture 52) to wrap his or her hand around handle 16, thereby providing a means by which to securely grip, hold and handle paint roller grid 10. In FIGS. 12A and 12B, a user 58 inserts his or fingers through aperture 52 from the front of paint roller grid 10. FIG. 12A is a front perspective view and FIG. 12B is a back perspective view of paint roller grid 10. The palm of the user 58 engages top surface 60, and the user's fingers wrap around front handle wall 64 and bottom handle wall 66 so that the fingertips curl up on a back side of paint roller grid 10, as shown in FIG. 12B, into the open space between handle reinforcement ribs 14.

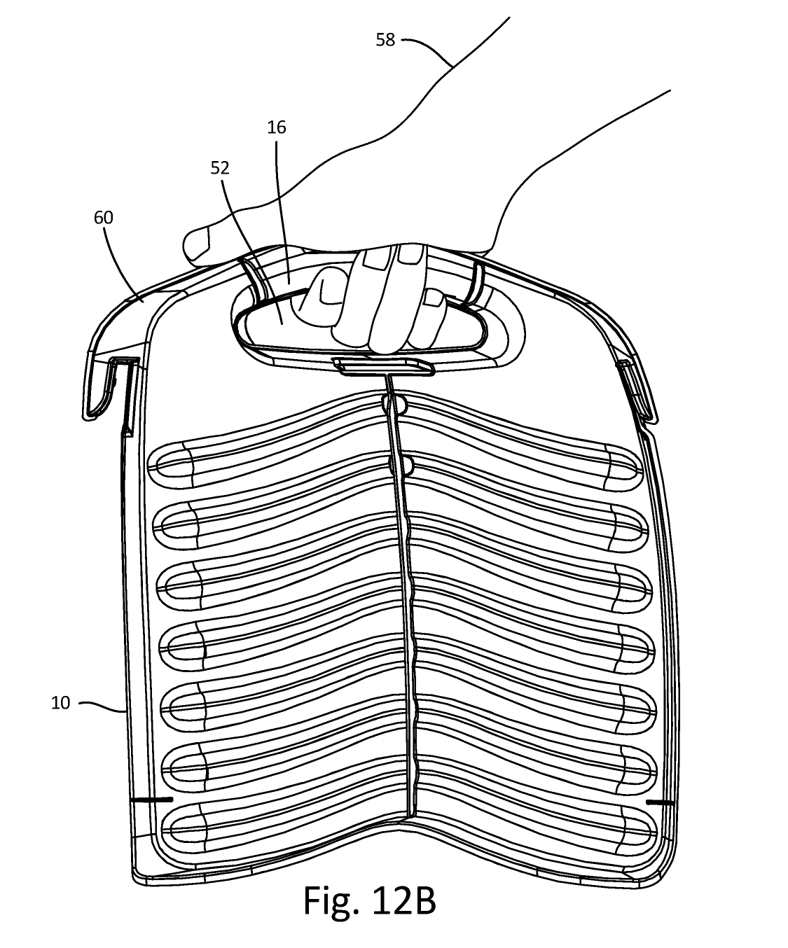

In FIGS. 13A and 13B, a user 58 inserts his or fingers through aperture 52 from the back of paint roller grid 10. FIG. 13A is a front perspective view and FIG. 13B is a back perspective view of paint roller grid 10. The palm of the user 58 engages top surface 60, and the user's fingers wrap around the back of handle 16 so that the fingertips curl up on bottom handle wall 66 and front handle wall 64, as shown in FIG. 13B.

In an exemplary embodiment, aperture 52 has a substantially oval shape with rounded surfaces. In the illustrated embodiments, aperture 52 has rounded surfaces on a front side of paint roller grid 10 (as shown in FIGS. 1 and 2) and terminates in a substantially oval shaped rim 54 on a back side of paint roller grid 10 (as shown in FIG. 3). Aperture 52 is defined by handle bottom wall 66, panel top wall 49 and aperture side walls 68. In an exemplary embodiment, handle bottom wall 66, panel top wall 49 and aperture side walls 68 flow smoothly into each other, with no discernable interfaces, in a substantially oval shape.

In an exemplary embodiment, handle 16 includes notch 56 on bottom handle wall 66 to allow paint roller grid 10 to hang from a peg member, such as one commonly found in retail displays.

FIG. 10 is a front perspective view of a user 58 rolling the roller 46 of a paint roller 34 against panel 32 of paint roller grid 10. Typically, a user dips roller 46 into a pool of paint or other fluid contained within container 24 to coat roller 46 with the paint or fluid. The user 58 can then press roller 46 against panel 32 while moving handle 42 up and down to remove excess paint from roller 46 and more evenly distribute the paint upon the surface of roller 46. The excess paint is captured by ridges 36 and flows by gravity along ridges 36 toward left and right side walls 38, 40, respectively. The excess paint also flows down panel 32 and back into the pool of fluid within container 24. The structure of panel 32 provides a uniform load of paint on paint roller 34 without pulling fabric from the roller 34 as conventional metal grids can. The paint roller grid 10 is held firmly in place during this process relative to the container 24 by the hooks 26 and engaged lower corners 75a and 75b.

Many conventional paint roller screens have holes therein, which can make the conventional screens difficult to clean, as paint and other surface treatment fluids can dry within the holes. In one embodiment, the exemplary paint roller grid 10 of the present disclosure does not have holes through panel 32, allowing for quick and easy clean-up after painting. The smooth and rounded contours of ridges 36 and panel 32 also increase the longevity of paint roller grid 10 in use, as less residue from paint and other chemicals is trapped on the surface of panel 32, compared to the surfaces of conventional paint roller screens. While an exemplary pattern for ridges 36 is illustrated, it is contemplated that a textured surface can be provided on panel 32 using an array of other raised elements, such as a pattern of bumps or other ridges (that may be round, straight, curved, and/or generally parallel, or any combination thereof). Ridges 36 facilitate uniform distribution of paint on a paint roller 34 and also enhance the aesthetic appearance of the paint roller grid 10.

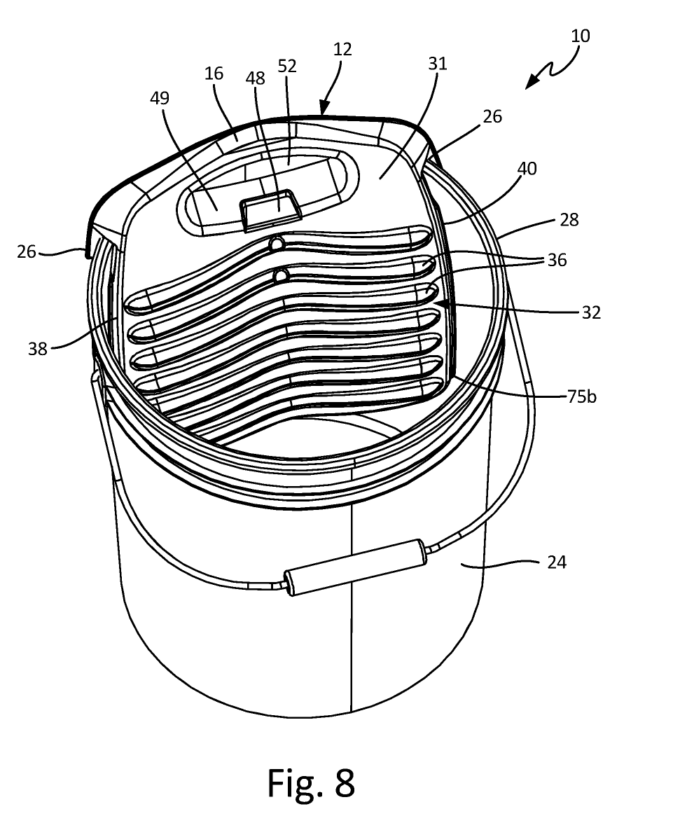

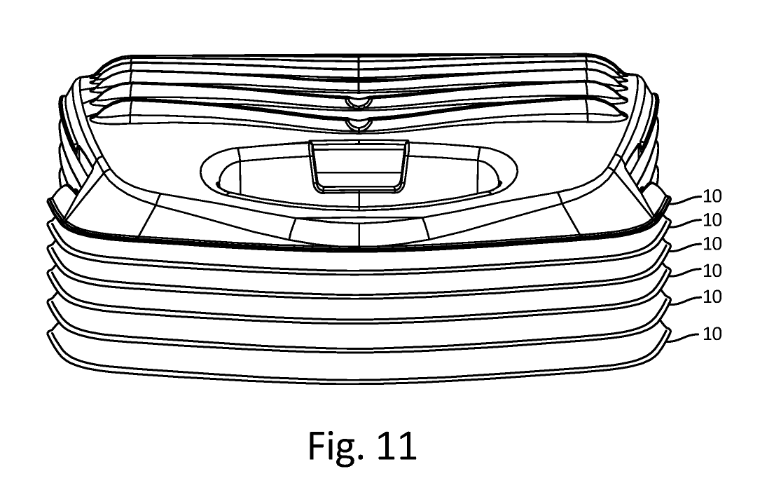

FIG. 11 is a view similar to FIG. 6, but shows six paint roller grids 10 stacked upon each other. As shown in FIGS. 1-7 and 11, in an exemplary embodiment, each of top surface 30, left edge surface 38 and right edge surface 40 extends from upper front face 31 or panel 32 at an obtuse angle to allow for efficient nesting of paint roller grids 10 when stacked, as shown in FIG. 11. Moreover, bottom handle wall 66, side walls 68 of aperture 52 and top wall 49 of panel 32 are also canted to facilitate stacking. This nesting feature allows for efficient use of space, enhancing efficiency in packaging, transport, retail display and storage functions.

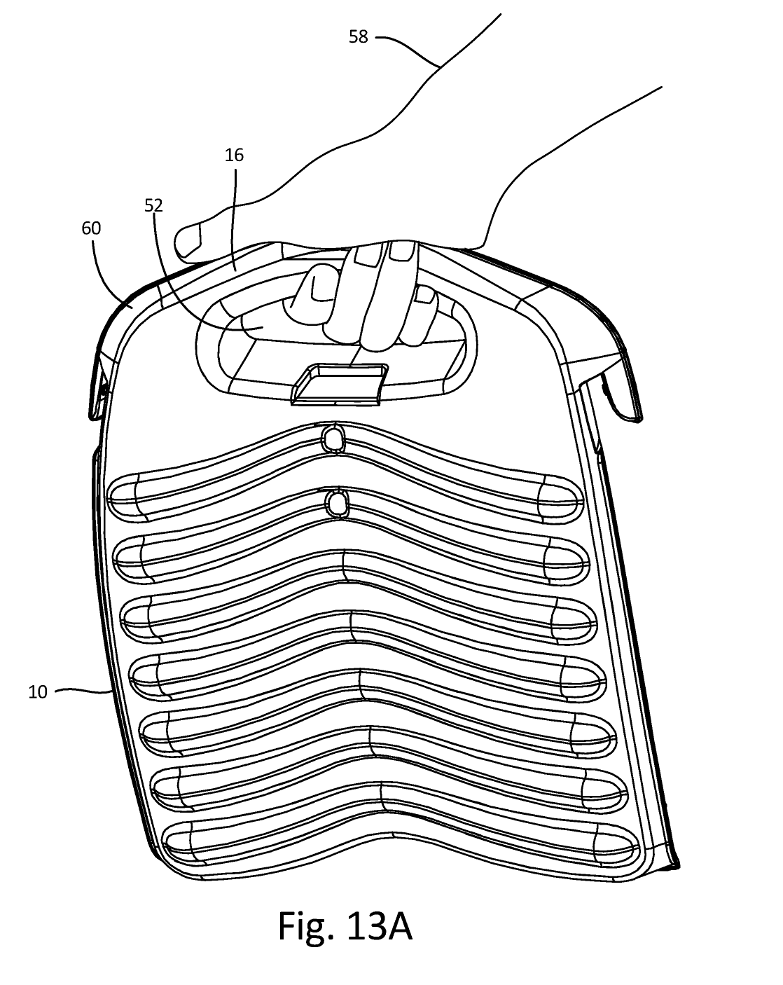

FIG. 14 is a back view of the exemplary paint roller grid 10 in a combination 70 with three paint rollers 46. In an exemplary embodiment, shell 12 includes cavity 72 in a rear thereof defined by panel 32 between top panel wall 49, left side wall 38, right side wall 40, and bottom wall 62. In combination 70, a plurality of paint rollers 46 are arranged side-by-side and at least partially contained in cavity 72; a depth of paint rollers 46 may extend beyond the depth of top panel wall 49, left side wall 38, right side wall 40, and bottom wall 62. Moreover, depending on the relative sizes of paint rollers 46 and cavity 72, a combination may include more or fewer paint rollers 46 packaged with a particular paint roller grid 10. A package or kit containing combination 70 or another combination is particularly suitable for retail display and sales.

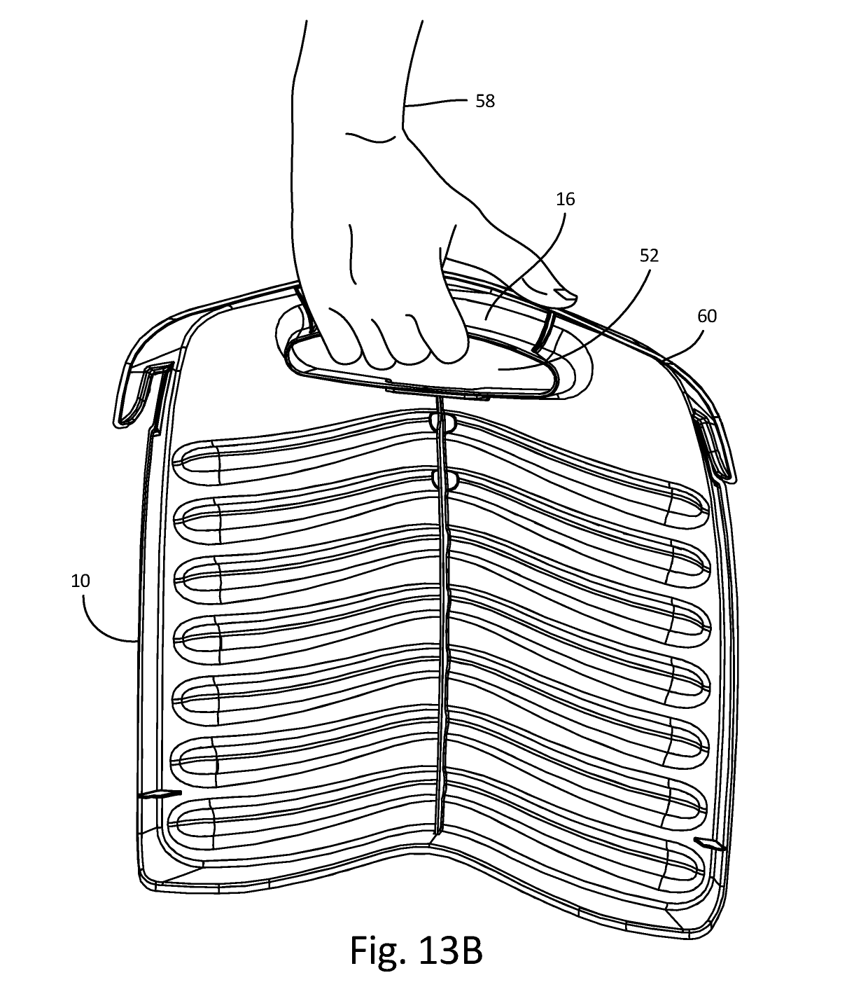

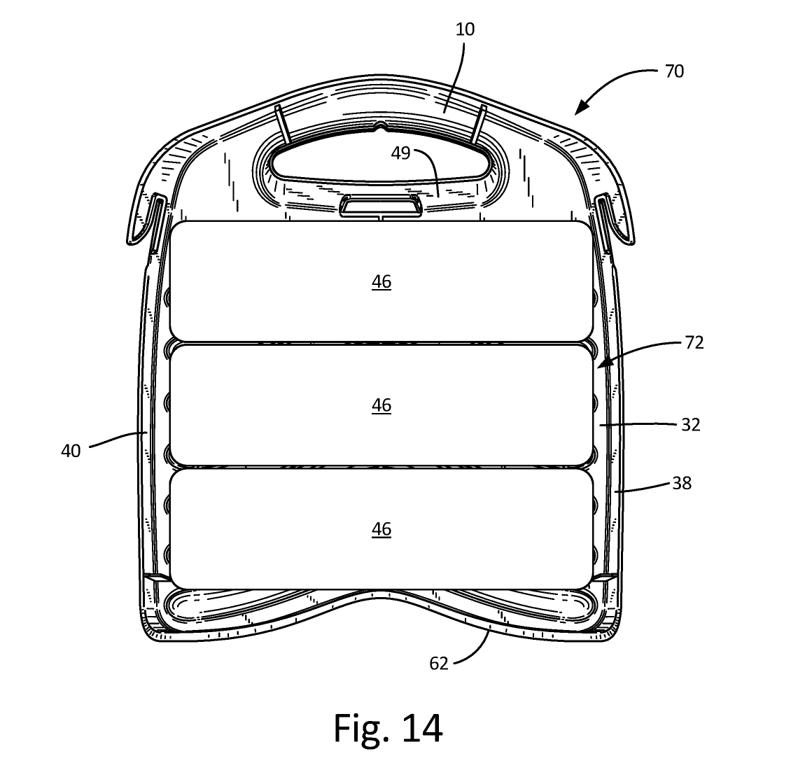

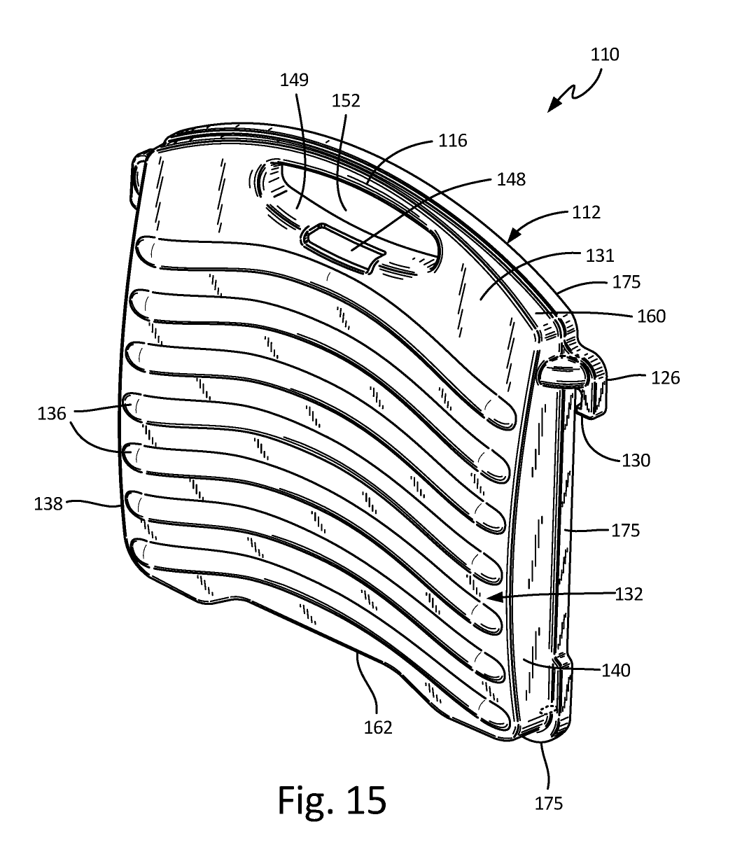

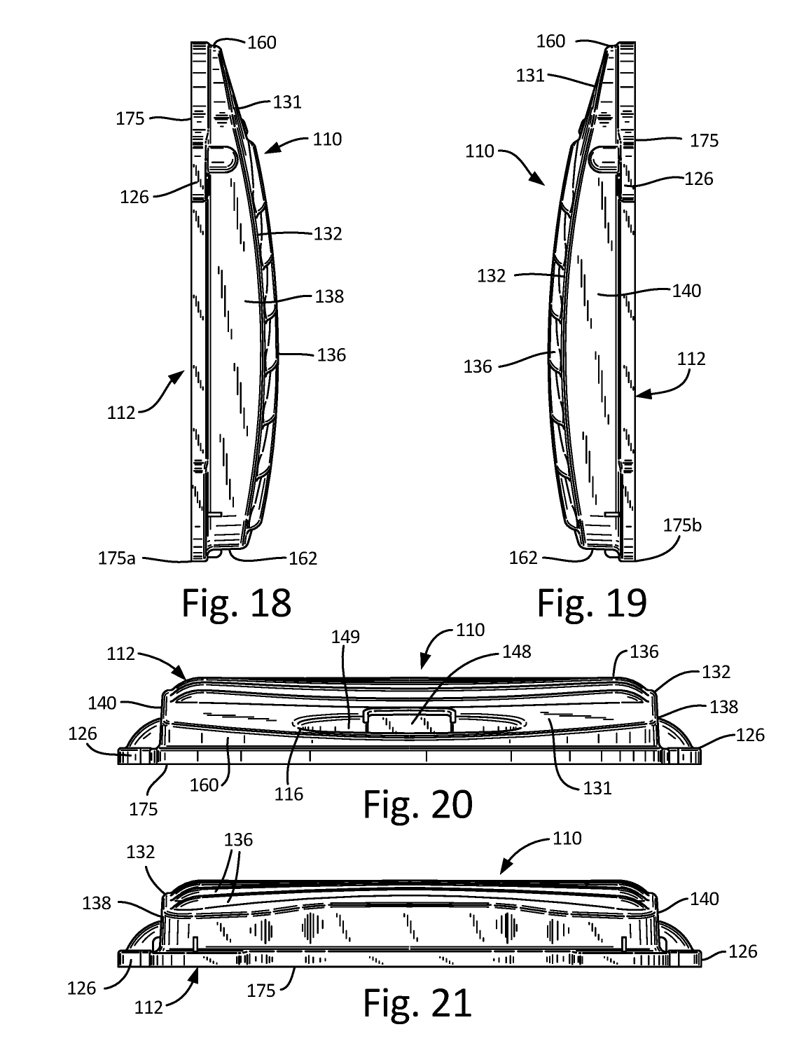

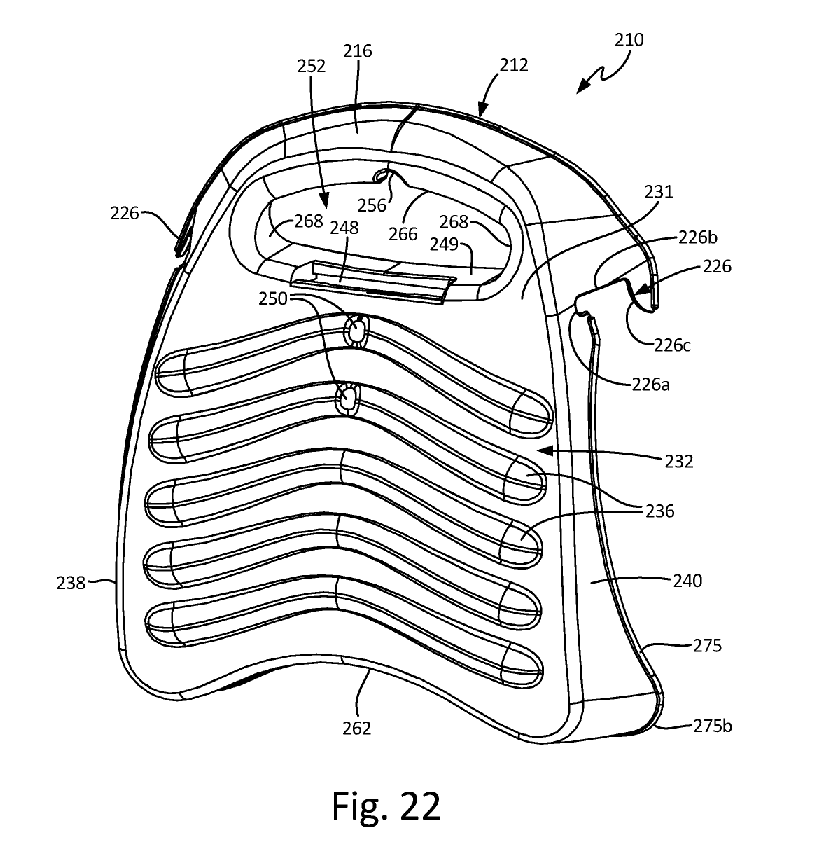

FIG. 15 is a front perspective view of a second exemplary paint roller grid apparatus 110 of the present disclosure. FIG. 16 is a front view thereof, and FIG. 17 is a back view thereof. As shown in FIGS. 15-21, in an exemplary embodiment, paint roller grid 110 is formed in a single piece. Such forming may be by a method such as injection molding, for example. In an exemplary embodiment, paint roller grid 110 can be considered to be constructed as a shell 112. In an exemplary embodiment, paint roller grid 110 is symmetrical about center line 122.

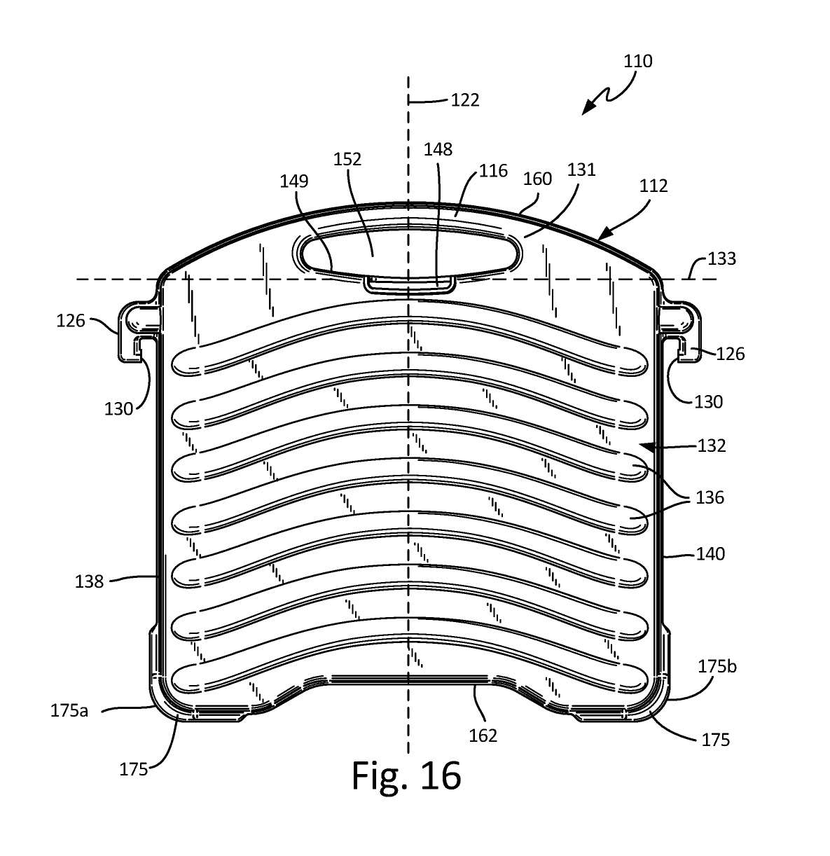

Such a shell construction provides for a light-weight structure that offers enhanced ease of use and prevents user fatigue. The light-weight shell structure also provides for material savings and increases economies in manufacturing and transport. The paint roller grid 110 may be formed of a suitable material (such as polypropylene or other similar plastic) to withstand the harmful effects of paint, stain or varnish, and to provide a durable and generally rigid paint roller grid structure. FIGS. 18, 19, 20 and 21 are left, right, top and bottom views, respectively, of the exemplary paint roller grid 110.

In FIGS. 15-21, parts of the second exemplary paint roller grid 110 corresponding to the parts of the first exemplary paint roller grid 10 of FIGS. 1-14 are labeled similarly, with the reference numbers increased by 100 for the second exemplary paint roller grid 110. It is to be understood that all discussion relevant to the parts discussed with reference to paint roller grid 10 also apply to the similarly numbered parts of paint roller grid 110, unless otherwise indicated.

Panel 132 provides a textured rolling surface for a paint roller. In an exemplary embodiment, panel 132 comprises a plurality of ridges 136, thereby offering a textured surface on which a paint roller rolls. In an exemplary embodiment, each ridge 136 is a curvilinear element having rounded edges, wherein the highest point of the curve is along center line 122. Accordingly, paint or another fluid on the surface of panel 132 is channeled by gravity away from center line 122 and toward and along the side walls 138, 140 of paint roller grid 110. The paint or other fluid then flows by gravity down paint roller grid 110 and back into the pool of fluid in a container on which paint roller grid 110 is attached. This feature prevents pooling of fluids on panel 132, thereby allowing the surface of the panel 132 to accept paint applied thereto from the paint roller.

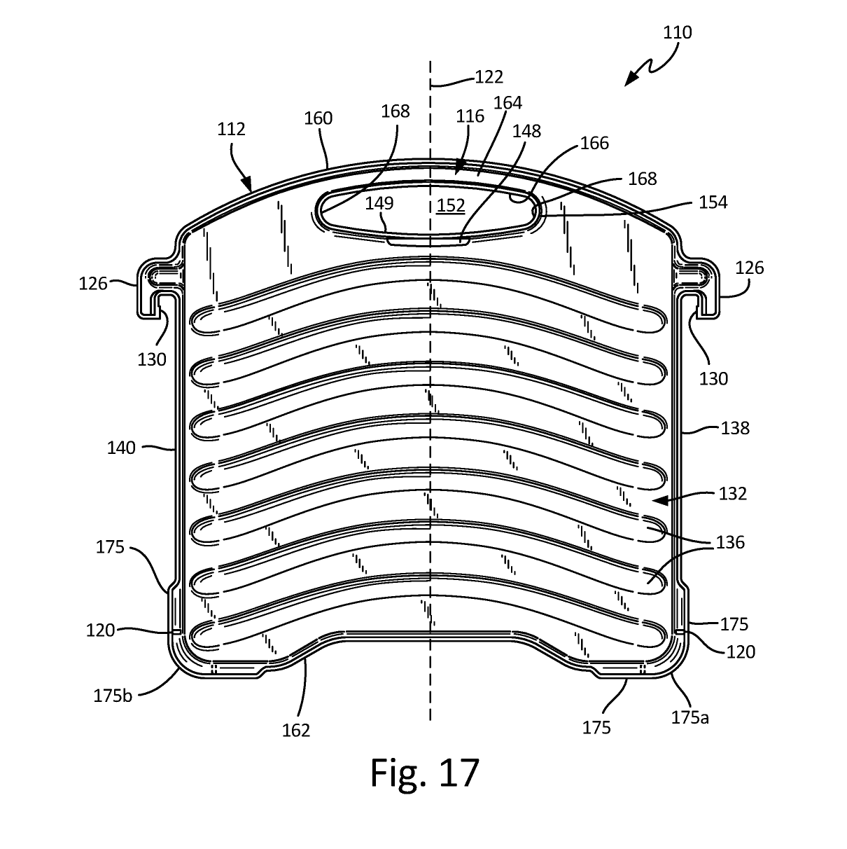

As shown in FIGS. 18 and 19 in an exemplary embodiment, paint roller grid 110 has a convex curvature of handle 116, upper front face 131 and panel 132. In an exemplary embodiment, upper front face 131 and panel 132 are continuous with each other and interface at an uninterrupted surface at demarcation line 133. With reference to FIG. 16, for ease of discussion, this disclosure refers to the front surface of paint roller grid 110 above wall 149 and demarcation line 133 as upper front face 131 and the front surface of paint roller grid 110 below wall 149 and demarcation line 133 as panel 132. In an exemplary embodiment, demarcation line 133 marks the level on paint roller grid 110 at which wall 149 extends back from the front surface of paint roller grid 110.

The convex curvature of panel 132 allows for ease of contact between a paint roller and top, middle and bottom portions of panel 132. Moreover, the curvature allows for a greater clearance space between a bottom of panel 132 and an interior of a container when in use, allowing for more space for maneuvering a paint roller within the container than might be available with a panel not having a curvature. The curvature also encourages paint run-off toward the bottom by gravity.

In an exemplary embodiment, from the front view and rear views, it can be seen that bottom wall substantially 162 follows the contours of ridges 136. This curvature of bottom wall 162 contributes to an aesthetically pleasing paint roller grid 110. In an exemplary embodiment, paint roller grid 110 is sized with respect to a container for which it will be used so that a length of panel 132 between hooks 126 and bottom wall 162 is such that a clearance height between the bottom wall 162 and the bottom of container allows for passage of at least the diameter of a paint roller. Thus, a user may maneuver the paint roller within the container and under paint roller grid 110, such as to stir a liquid contained therein or capture remnants of the liquid on the paint roller, for example.

In an exemplary embodiment, left and right side walls 138, 140 extend back from panel 132 to hold panel 132 away from an interior surface of a container, thereby preventing fluid buildup on the left and right walls 138, 140 of paint roller grid 110. Moreover, left and right side walls 138, 140 lend rigidity to the shell 112 of paint roller grid 110. As shown in FIGS. 15-21, a thickened edge rim 175 on top wall 160, left and right side walls 138, 140 and bottom wall 162 is provided to additionally lend rigidity to the shell 112. Lower corners 175a and 175b of the rim 175 (see, e.g., FIGS. 16-19) engage an inner surface of the side wall of a container when the paint roller grid 110 is mounted on the container for use, adding further stability to the paint roller grid 110 as a user contacts it with a paint roller.

In an exemplary embodiment, handle 116 is formed as a semi-tubular element having rounded top, front and bottom walls with an open back, as show in FIGS. 15-17 and 20. Aperture 152 is provided between handle 116 and panel 132. In an exemplary embodiment, as shown in FIG. 17, for example, handle 116 includes a central portion of top wall 160, front handle wall 164, and bottom handle wall 166. In an exemplary embodiment, top wall 160, front handle wall 164 and bottom handle wall 166 are continuous with each other and flow smoothly into each other, with no discernable interfaces, in a semi-tubular shape. Top wall 160, front handle wall 164 and bottom handle wall 166 are curved for user comfort and aesthetic value.

In a typical method of use, a user inserts his or her fingers through aperture 152 (from the front or back of aperture 152) to wrap his or her hand around handle 116, thereby providing a means by which to securely grip, hold and handle paint roller grid 110. In an exemplary embodiment, aperture 152 has a substantially oval shape with rounded surfaces. In the illustrated embodiments, aperture 152 has rounded surfaces on a front side of paint roller grid 110 (as shown in FIGS. 15 and 16) and terminates in a substantially oval shaped rim 154 on a back side of paint roller grid 110 (as shown in FIG. 17). Aperture 152 is defined by handle bottom wall 166, panel top wall 149 and aperture side walls 168. In an exemplary embodiment, handle bottom wall 166, panel top wall 149 and aperture side walls 168 flow smoothly into each other, with no discernable interfaces, in a substantially oval shape.

Many conventional paint roller screens have holes therein, which can make the conventional screens difficult to clean, as paint and other surface treatment fluids can dry within the holes. In one embodiment, the exemplary paint roller grid 110 of the present disclosure does not have holes through panel 132, allowing for quick and easy clean-up after painting. The smooth and rounded contours of ridges 136 and panel 132 also increase the longevity of paint roller grid 110 in use, as less residue from paint and other chemicals is trapped on the surface of panel 132, compared to the surfaces of conventional paint roller screens. While an exemplary pattern for ridges 136 is illustrated, it is contemplated that a textured surface can be provided on panel 132 using an array of other raised elements, such as a pattern of bumps or other ridges (that may be round, straight, curved, and/or generally parallel, or any combination thereof). Ridges 136 facilitate uniform distribution of paint on a paint roller 134 and also enhance the aesthetic appearance of the paint roller grid 110.

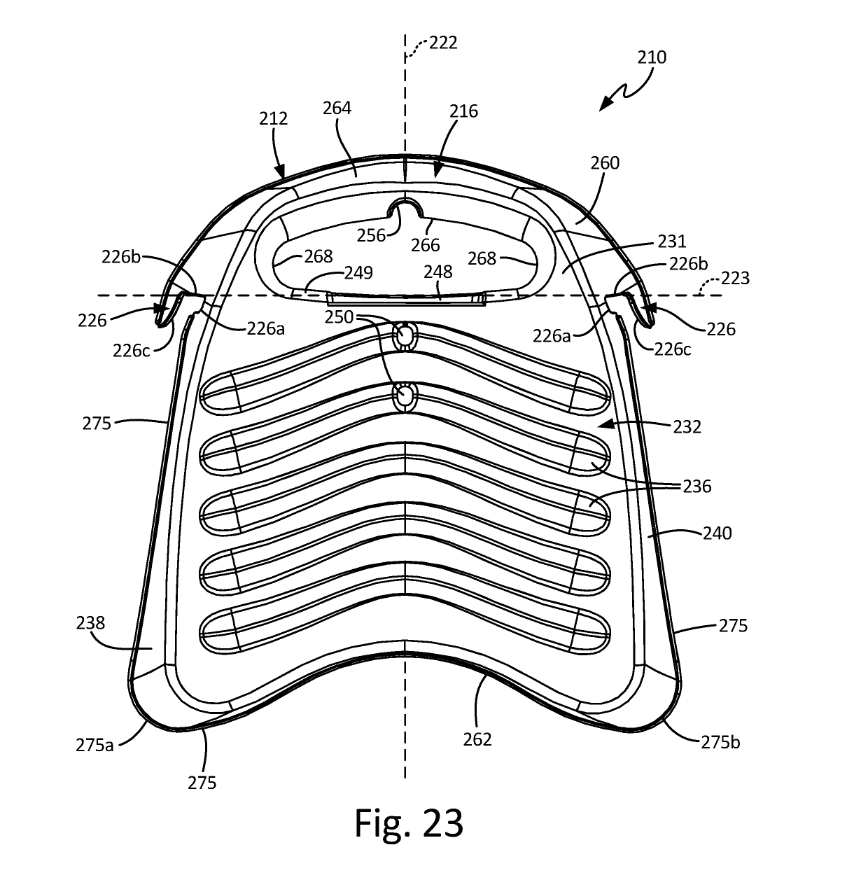

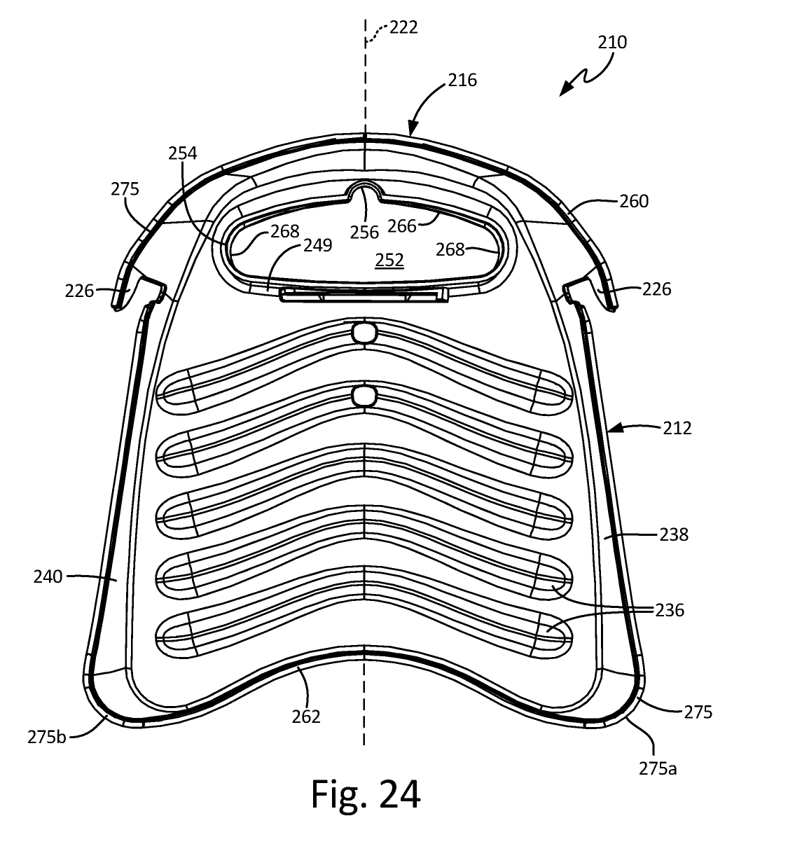

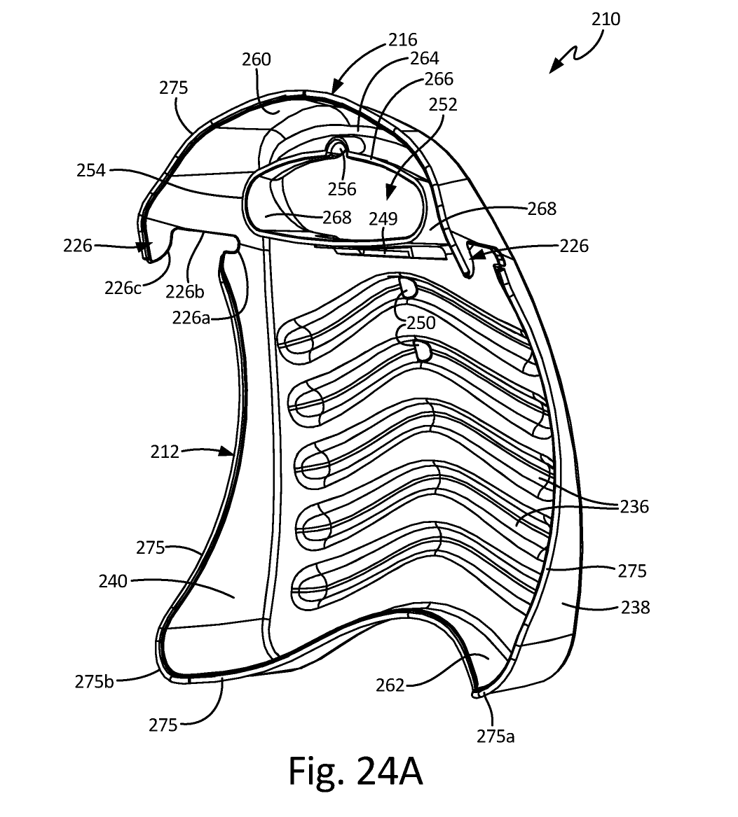

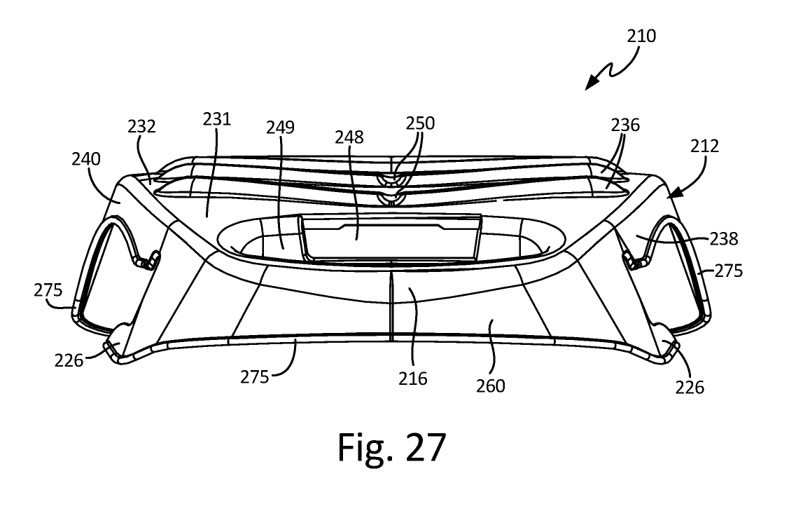

FIG. 22 is a front perspective view of a third exemplary paint roller grid apparatus 210 of the present disclosure. FIG. 23 is a front view thereof, and FIG. 24 is a back view thereof. As shown in FIGS. 22-29, in an exemplary embodiment, paint roller grid 210 is formed in a single piece. Such forming may be by a method such as injection molding, for example. In an exemplary embodiment, paint roller grid 210 can be considered to be constructed as a shell 212. In an exemplary embodiment, paint roller grid 210 is symmetrical about center line 222.

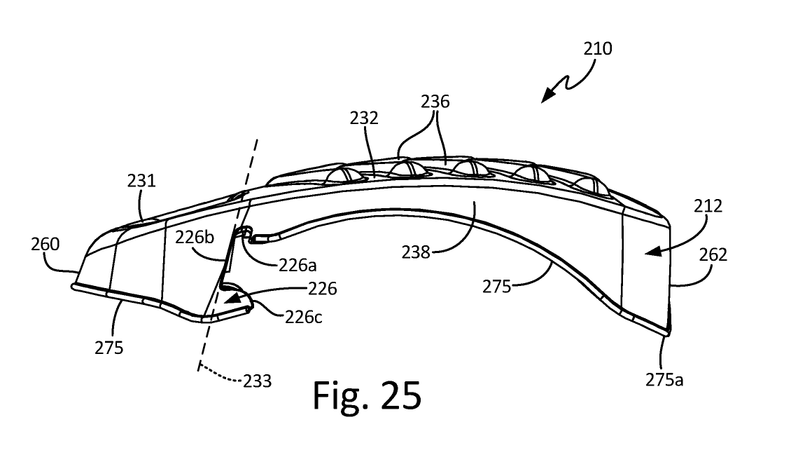

Such a shell construction provides for a light-weight structure that offers enhanced ease of use and prevents user fatigue. The light-weight shell structure also provides for material savings and increases economies in manufacturing and transport. The paint roller grid 210 may be formed of a suitable material (such as polypropylene or other similar plastic) to withstand the harmful effects of paint, stain or varnish, and to provide a durable and generally rigid paint roller grid structure. FIGS. 25, 26, 27 and 28 are left, right, top and bottom views, respectively, of the exemplary paint roller grid 210.

In FIGS. 22-29, parts of the third exemplary paint roller grid 210 corresponding to the parts of the first exemplary paint roller grid 10 of FIGS. 1-14 are labeled similarly, with the reference numbers increased by 200 for the third exemplary paint roller grid 210. It is to be understood that all discussion relevant to the parts discussed with reference to paint roller grid 10 also apply to the similarly numbered parts of paint roller grid 210, unless otherwise indicated.

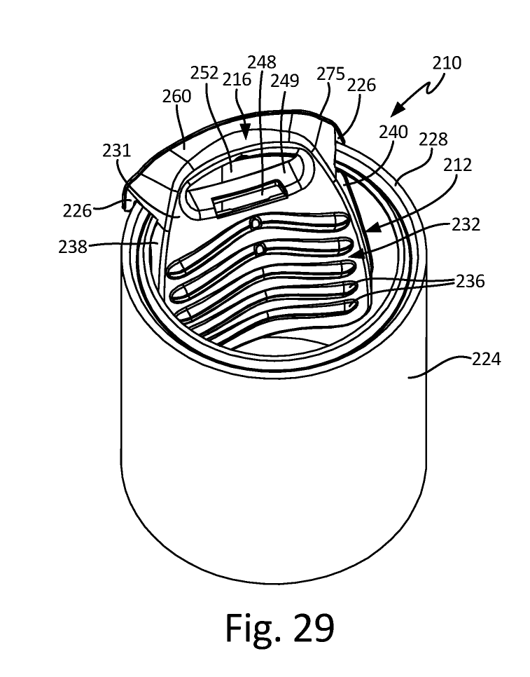

FIG. 29 is a perspective view of paint roller grid 210 attached to a container 224 configured for holding paint or another substance to be applied to a surface by a user. In the illustrated embodiment, container 224 is a conventional 1-gallon paint can. However, other suitable containers include paint pails and other buckets and containers of varying sizes. Moreover, it is contemplated that paint roller grid 210 may be provided in different sizes to fit containers 224 of different sizes.

As shown in FIG. 29, hooks 226 are positioned to hang over top rim 228 of container 224. In this embodiment, each side wall 238 and 240 includes a notch 226a disposed opposite and forwardly from its respective hook 26, with a linear notch-hook connecting edge 226b extending from the top of each notch 226a to a top of each front edge 226c of its respective hook 226 (see, e.g., FIG. 22). This hook/notch/edge assembly cooperates to firmly retain (e.g., via a snap-fit engagement) the paint roller grid 210 onto the rim 228 of the container 224, as seen in FIG. 29. The two-point engagement of hooks 226 with rim 228 stably retains paint roller grid 210 on container 224 during use, such as when force is exerted on paint roller grid 210 by a user exerting force and motion on a paint roller upon panel 232.

In an exemplary embodiment, when paint roller grid 210 is assembled onto container 224, handle 216 extends above rim 228 and panel 232 extends below rim 228. Panel 232 provides a textured rolling surface for a paint roller. In an exemplary embodiment, panel 232 comprises a plurality of ridges 236, thereby offering a textured surface on which a paint roller rolls. In an exemplary embodiment, each ridge 236 is a curvilinear element having rounded edges, wherein the highest point of the curve is along center line 222. Accordingly, paint or another fluid on the surface of panel 232 is channeled by gravity away from center line 222 and toward and along the side walls 238, 240 of paint roller grid 210. The paint or other fluid then flows by gravity down paint roller grid 210 and back into the pool of fluid in container 224. This feature prevents pooling of fluids on panel 232, thereby allowing the surface of the panel 232 to accept paint applied thereto from the paint roller.

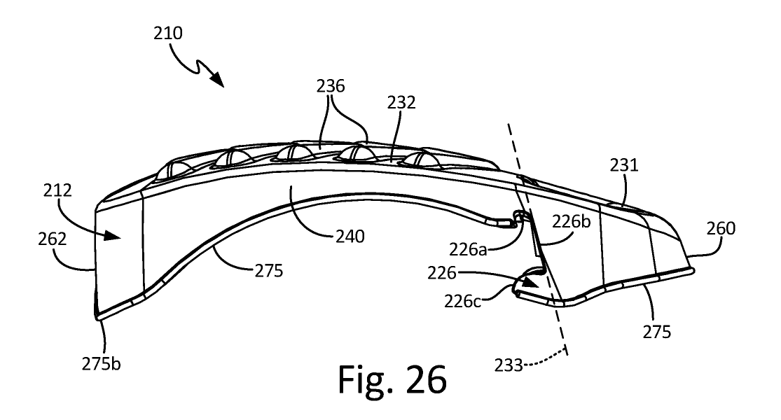

As shown in FIGS. 25 and 26 in an exemplary embodiment, paint roller grid 210 has a convex curvature of handle 216, upper front face 231 and panel 232. In an exemplary embodiment, upper front face 231 and panel 232 are continuous with each other and interface at an uninterrupted surface at demarcation line 233. With reference to FIG. 23, for ease of discussion, this disclosure refers to the front surface of paint roller grid 210 above wall 249 and demarcation line 233 as upper front face 231 and the front surface of paint roller grid 210 below wall 249 and demarcation line 233 as panel 232. In an exemplary embodiment, demarcation line 233 marks the level on paint roller grid 210 at which wall 249 extends back from the front surface of paint roller grid 210. Moreover, in an exemplary embodiment, demarcation line 233 marks the location at which hooks 226 extend downward from top wall 260. Thus, when paint roller grid 210 is attached to container 224 as shown in FIG. 29, demarcation line 233 marks the level of rim 228 of container 224. In one exemplary embodiment, the notch-hook connecting edges 226b are co-linear with demarcation line 233 when the paint roller grid 210 is attached to container 224.

The convex curvature of panel 232 allows for ease of contact between a paint roller and top, middle and bottom portions of panel 232. Moreover, the curvature allows for a greater clearance space between a bottom of panel 232 and an interior of container 224, allowing for more space for maneuvering a paint roller within container 224 than might be available with a panel not having a curvature. The curvature also encourages paint run-off toward the bottom by gravity.

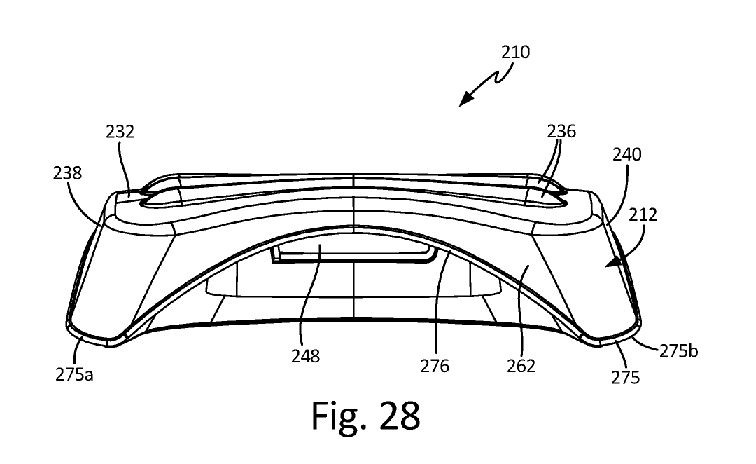

In an exemplary embodiment, from the front view and rear views, it can be seen that bottom wall 262 follows the contours of ridges 236. Moreover, as shown in FIG. 28, panel 232 is also has a convex curvature across its width. Bottom wall 262 follows this curvature in an exaggerated manner, resulting in a curved back edge 276 of bottom wall 262. This curvature of bottom wall 262 contributes to an aesthetically pleasing paint roller grid 210. In an exemplary embodiment, paint roller grid 210 is sized with respect to a container 224 for which it will be used so that a length of panel 232 between hooks 226 and bottom wall 262 is such that a clearance height between the bottom wall 262 and the bottom of container 224 allows for passage of at least the diameter of a paint roller. Thus, a user may maneuver the paint roller within the container 224 and under paint roller grid 210, such as to stir a liquid contained therein or capture remnants of the liquid on the paint roller, for example.

In an exemplary embodiment, left and right side walls 238, 240 are angled back from panel 232 to hold panel 232 away from an interior surface of container 224, thereby preventing fluid buildup on the left and right walls 238, 240 of paint roller grid 210. Moreover, left and right side walls 238, 240 lend rigidity to the shell 212 of paint roller grid 210. A thickened edge rim 275 on top wall 260, left and right side walls 238, 240 and bottom wall 262 is provided to additionally lend rigidity to the shell 212. Lower corners 275a and 275b of the rim 275 (see, e.g., FIG. 24) engage an inner surface of the side wall of container 224, when the paint roller grid 210 is mounted on the container 224 for use, as seen in FIG. 29, adding further stability to the paint roller grid 210 as a user contacts it with a paint roller.

In an exemplary embodiment, handle 216 is formed as a semi-tubular element having rounded top, front and bottom walls with an open back, as show in FIGS. 22-24A and 27. Aperture 252 is provided between handle 216 and panel 232. In an exemplary embodiment, as shown in FIGS. 24 and 24A, for example, handle 216 includes a central portion of top wall 260, front handle wall 264, and bottom handle wall 266. In an exemplary embodiment, top wall 260, front handle wall 264 and bottom handle wall 266 are continuous with each other and flow smoothly into each other, with no discernable interfaces, in a semi-tubular shape. Top wall 260, front handle wall 264 and bottom handle wall 266 are curved for user comfort and aesthetic value.

In a typical method of use, a user inserts his or her fingers through aperture 252 (from the front or back of aperture 252) to wrap his or her hand around handle 216, thereby providing a means by which to securely grip, hold and handle paint roller grid 210. In an exemplary embodiment, aperture 252 has a substantially oval shape with rounded surfaces. In the illustrated embodiments, aperture 252 has rounded surfaces on a front side of paint roller grid 210 (as shown in FIGS. 22 and 23) and terminates in a substantially oval shaped rim 254 on a back side of paint roller grid 10 (as shown in FIGS. 24 and 24A). Aperture 252 is defined by handle bottom wall 266, panel top wall 249 and aperture side walls 268. In an exemplary embodiment, handle bottom wall 266, panel top wall 249 and aperture side walls 268 flow smoothly into each other, with no discernable interfaces, in a substantially oval shape.

In an exemplary embodiment, handle 216 includes notch 256 on bottom handle wall 266 to allow paint roller grid 210 to hang from a peg member, such as one commonly found in retail displays.

Many conventional paint roller screens have holes therein, which can make the conventional screens difficult to clean, as paint and other surface treatment fluids can dry within the holes. In one embodiment, the exemplary paint roller grid 210 of the present disclosure does not have holes through panel 232, allowing for quick and easy clean-up after painting. The smooth and rounded contours of ridges 236 and panel 232 also increase the longevity of paint roller grid 210 in use, as less residue from paint and other chemicals is trapped on the surface of panel 232, compared to the surfaces of conventional paint roller screens. While an exemplary pattern for ridges 236 is illustrated, it is contemplated that a textured surface can be provided on panel 232 using an array of other raised elements, such as a pattern of bumps or other ridges (that may be round, straight, curved, and/or generally parallel, or any combination thereof). Ridges 236 facilitate uniform distribution of paint on paint roller and also enhance the aesthetic appearance of the paint roller grid 210.

Although the subject of this disclosure has been described with reference to several embodiments, workers skilled in the art will recognize that changes may be made in form and detail without departing from the spirit and scope of the disclosure. In addition, any feature disclosed with respect to one embodiment may be incorporated in another embodiment, and vice-versa.

What is claimed is:

1. An apparatus configured for use with a container having a top rim, the apparatus comprising:
a plurality of hooks configured to hang on the rim;
a handle extending above the rim and comprising a semi-tubular shape; and
a panel extending below the rim and comprising a textured surface, the textured surface comprising an array of raised elements.

2. The apparatus of claim 1 formed as a single piece of material.

3. The apparatus of claim 1 further comprising a protrusion positioned on at least one of the plurality of hooks, the protrusion configured to engage with the rim.

4. The apparatus of claim 1 wherein the array of raised elements comprises a plurality of curvilinear ridges.

5. The apparatus of claim 1 wherein at least one of the plurality of curvilinear ridges comprises a peak along a center line of the apparatus.

6. The apparatus of claim 1 that is symmetrical about a center line.

7. The apparatus of claim 1 further comprising an aperture between the handle and the panel.

8. The apparatus of claim 1 further comprising an aperture positioned on a top wall of the panel.

9. The apparatus of claim 1 further comprising a recess positioned on at least one of the raised elements.

10. The apparatus of claim 1 having a shell construction and a plurality of reinforcement members.

11. The apparatus of claim 10 wherein the plurality of reinforcement members comprises a handle reinforcement member positioned in the handle.

12. The apparatus of claim 10 wherein the plurality of reinforcement members comprises a central reinforcement member positioned along a central line of symmetry of the apparatus.

13. The apparatus of claim 10 wherein the plurality of reinforcement members comprises a side reinforcement member contacting a side wall of the apparatus.

14. The apparatus of claim 10 wherein the panel comprises a convex curvature.

15. The apparatus of claim 1 further comprising a side wall extending from the textured surface.

16. The apparatus of claim 15 wherein the side wall extends from the textured surface at an obtuse angle.

17. The apparatus of claim 1 wherein the handle comprises a notch therein.
